(19) United States
(12) Patent Application Publication
(10) Pub. No.: US 2005/0185017 A1
(43) Pub. Date: Aug. 25, 2005

(54) Method of making an inkjet printhead

(75) Inventors: Phil Keenan, Dublin (IE); Kevin Dooley, Wicklow (IE); Liam Ryan, Dublin (IE); Elizabeth Harvey, Dublin (IE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/041,991

(22) Filed: Jan. 26, 2005

(30) Foreign Application Priority Data
Jan. 29, 2004 (GB) 0401872.7

(51) Int. Cl. B41J 2/135

(52) U.S. Cl. 347/40; 347/45

(57) ABSTRACT

A method of making an inkjet printhead comprises forming at least one ink ejection element 18, 36 on a surface 14 of a substrate 10, forming a slot 12 in the substrate to provide fluid communication between an ink supply and the ink ejection element, and subjecting the slotted substrate to an isotropic etch.

### TECHNICAL FIELD

This invention relates to a method of making an inkjet printhead.

### BACKGROUND ART

Inkjet printers operate by ejecting small droplets of ink from individual orifices in an array of such orifices provided on a nozzle plate of a printhead. The printhead may form part of a print cartridge which can be moved relative to a sheet of paper and the timed ejection of droplets from particular orifices as the printhead and paper are relatively moved enables characters, images and other graphical material to be printed on the paper.

A typical conventional printhead is fabricated from a silicon substrate having thin film resistors and associated circuitry deposited on its front surface. The resistors are arranged in an array relative to one or more ink supply slots in the substrate, and a barrier material is formed on the substrate around the resistors to isolate each resistor inside a thermal ejection chamber. The barrier material is shaped both to form the thermal ejection chambers, and to provide fluid communication between the chambers and the ink supply slot. In this way, the thermal ejection chambers are filled by capillary action with ink from the ink supply slot, which itself is supplied with ink from an ink reservoir in the print cartridge of which the printhead forms part.

The composite assembly described above is typically capped by a metallic nozzle plate having an array of drilled orifices which correspond to and overlie the ejection chambers. The printhead is thus sealed by the nozzle plate, but permits ink flow from the print cartridge via the orifices in the nozzle plate.

The printhead operates under the control of printer control circuitry which is configured to energise individual resistors according to the desired pattern to be printed. When a resistor is energised it quickly heats up and superheats a small amount of the adjacent ink in the thermal ejection chamber. The superheated volume of ink expands due to explosive evaporation and this causes a droplet of ink above the expanding superheated ink to be ejected from the chamber via the associated orifice in the nozzle plate.

Many variations on this basic construction will be well known to the skilled person. For example, a number of arrays of orifices and chambers may be provided on a given printhead, each array being in communication with a different coloured ink reservoir. The configurations of the ink supply slots, printed circuitry, barrier material and nozzle plate are open to many variations, as are the materials from which they are made and the manner of their manufacture.

The typical printhead described above is normally manufactured simultaneously with many similar such printheads on a large area silicon wafer which is only divided up into individual printhead dies at a late stage in the manufacture. FIG. 1 is a plan view of the front surface of a substantially circular silicon wafer 10 typically used in the manufacture of printheads. The wafer 10 has a large number of slots 12 each extending fully through the thickness of the wafer. In FIG. 1 the slots 12 are grouped in threes, as would be the case where the wafer is to be used in the manufacture of printheads for colour printing. The rear surface (not seen in FIG. 1) of the wafer 10 has grooves running vertically between each group of three slots 12 and horizontally between each row of slots 12 so that ultimately the wafer can be divided up, for example, using a conventional dicing saw into individual “dies” each containing one group of three slots 12.

In the final printhead each slot 12 supplies ink to one or more ink ejection chambers disposed along one or both sides of the slot on the front surface of the wafer. Although, for reasons of mass production, the ink supply slots 12 are almost always formed in the undivided wafer 10, they can be formed at any of a number of different stages of production. For example, the slots 10 can be formed in the initial “raw” wafer, as seen in FIG. 1, or when the front surface of the wafer already bears part or all of the thin film resistors and other circuitry, provided the front surface of the wafer is suitably protected.

The slots 12 are conventionally formed by laser milling or sand blasting, usually from the rear surface of the wafer. A disadvantage associated with conventional techniques is that micron-sized chips and cracks are formed around the edges and on the surfaces of the slot. These minute flaws can act as initiation points for macro-sized cracks to appear in the wafer under stress, leading to breakage of the wafer or of dies subsequently cut from it. Such stress can result from thermal shock or high frequency fatigue, or just rough handling. Even if the wafer does not break, large parts of it may be rendered unusable and may have to be scrapped. In addition, the milling or blasting process can deposit minute particles of debris on the surfaces of the wafer, and these cannot always be removed by conventional cleaning techniques. Where such particles are not removed, this may result in blockage of the orifices in the printhead nozzle plate. Both these disadvantages can adversely impact the productivity of the manufacturing process and the manufacturing quality of the subsequent printheads.

It is an object of the invention to provide an improved method of making an inkjet printhead in which these disadvantages are avoided or mitigated.

### DISCLOSURE OF THE INVENTION

The invention provides a method of making an inkjet printhead comprising forming at least one ink ejection element on a surface of a substrate, forming an opening in the substrate to provide fluid communication between an ink supply and the ink ejection element, and subjecting the opening to a substantially isotropic etch.

As used herein, the terms “inkjet”, “ink supply slot” and related terms are not to be construed as limiting the invention to devices in which the liquid to be ejected is an ink. The terminology is shorthand for this general technology for printing liquids on surfaces by thermal, piezo or other ejection from a printhead, and while the primary intended application is the printing of ink, the invention will also be applicable to printheads which deposit other liquids in like manner.

The term “substantially isotropic” is used to indicate an etch which is substantially invariant with respect to direction and as such an etch which is only partially or slightly directed should be considered to fall with the scope of the present invention.

Furthermore, the method steps as set out herein and in the claims need not necessarily be carried out in the order stated, unless implied by necessity.

### BRIEF DESCRIPTION OF THE DRAWINGS

FIG. 1, previously described, is a plan view of a silicon wafer used in the manufacture of printheads according to an embodiment of the invention;

FIGS. 2 to 6 show successive steps in making a printhead according to the embodiment of the invention;

FIG. 7 is a cross-section of the final printhead made by the method of FIGS. 2 to 6;

FIG. 8 is a cross-sectional view of a print cartridge incorporating the printhead of FIG. 7;

FIGS. 9 to 12 are plots showing the results of experiments carried out to illustrate the improvements provided by the embodiment.

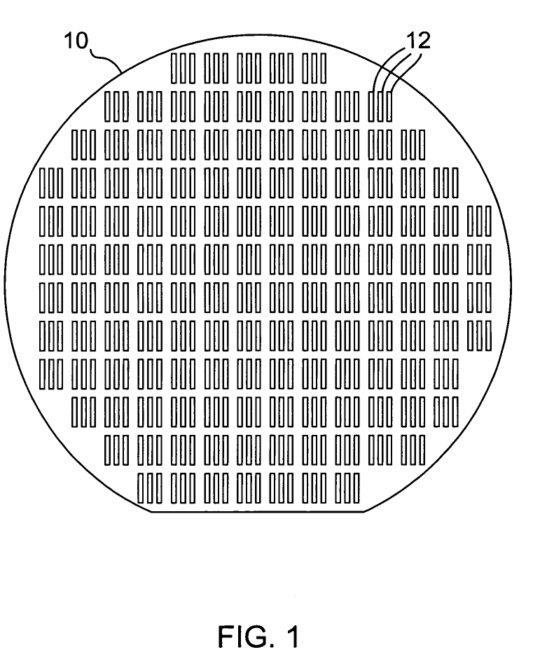

In the drawings, which are not to scale, the same parts have been given the same reference numerals in the various figures.

### DESCRIPTION OF PREFERRED EMBODIMENT

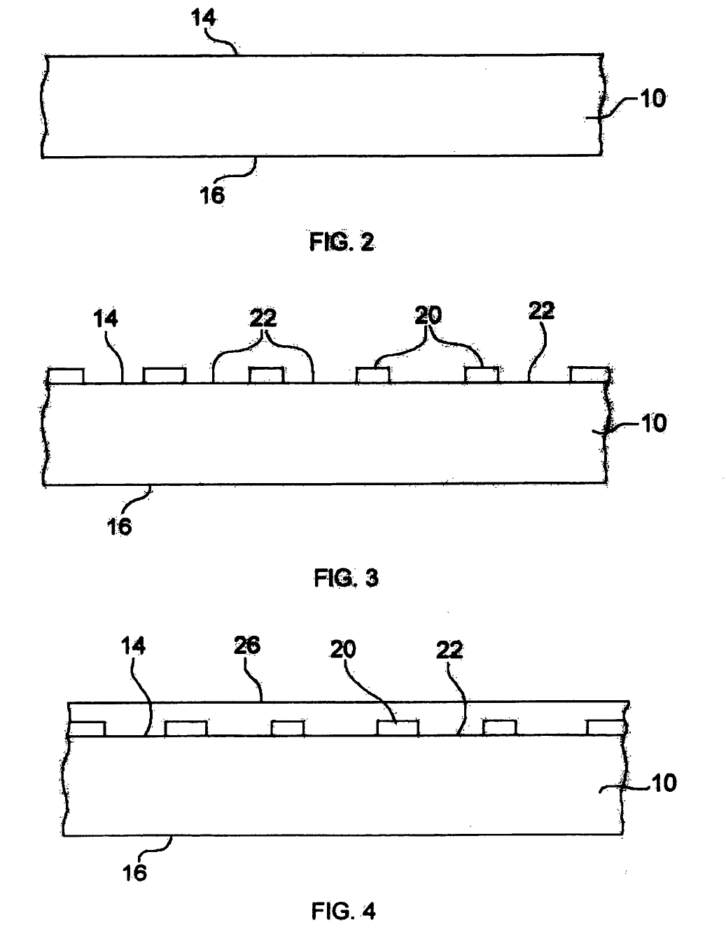

FIG. 2 shows, in fragmentary cross-sectional side view, a substantially circular silicon wafer 10 of the kind previously referred to and typically used in the manufacture of conventional inkjet printheads. The wafer 10 has a thickness of 675·m and a diameter of 150 mm. The wafer 10 has opposite, substantially parallel front and rear major surfaces 14 and 16 respectively, the front surface 14 being flat, highly polished and free of contaminants in order to allow ink ejection elements to be built up thereon by the selective application of various layers of materials in known manner.

The first step in the manufacture of a printhead according to the embodiment of the invention is to process the front surface 114 of the wafer in conventional manner to lay down an array of thin film heating resistors 18 (FIG. 7) which, in the embodiment, are connected via conductive traces to a series of contacts which are used to connect the traces via flex beams with corresponding traces on a flexible printhead-carrying circuit member (not shown) mounted on a print cartridge. The flexible printhead-carrying circuit member enables printer control circuitry located within the printer to selectively energise individual resistors under the control of software in known manner. As discussed, when a resistor 18 is energised it quickly heats up and superheats a small amount of the adjacent ink which expands due to explosive evaporation. The resistors 18, and their corresponding traces and contacts, are not shown in FIGS. 3 to 6 due to the small scale of these figures, but methods for their fabrication are well-known.

After laying down the resistors 18, a blanket barrier layer 20 of, for example, dry photoresist is applied to the entire front surface 14 of the wafer 10 and selected regions 22 of the photoresist are removed and the remaining portions of photoresist are hard baked. The result is shown in FIG. 3. Each region 22 is centered over a region of the substrate 10 where a respective slot 12 will be formed, and extends along substantially the full length of the slot. In the finished printhead, the regions 22 define the lateral boundaries of a plurality of ink ejection chambers 24, FIG. 7. Again, the formation of the barrier layer is part of the state of the art and is familiar to the skilled person.

Next, FIG. 4, a blanket protective layer 26 of polyvinyl alcohol (PVA) or any other suitable material is deposited over the entire front surface 14 of the wafer, covering the resistors 18, barrier layer 20 and other thin film circuitry. Now, FIG. 5, the ink supply slots 12 are laser machined fully through the thickness of the wafer 10 and PVA layer 26 using one or more narrow laser beams 28 (not all the slots 12 are necessarily machined simultaneously as suggested by the presence of beams 28 in all the slots 12 in FIG. 5). In other embodiments of the invention, the slots 12 could be cut by reactive ion etching, wet etching or sand blasting. In the preferred embodiment, the slots 12 are cut upwardly from the rear surface 16 as indicated by the arrows 28 representing the laser beams. In this embodiment each slot 12 is centered between a respective pair of adjacent barrier portions 20.

Now the wafer 10, including its protective PVA layer 26, is subjected to an isotropic etch. In the present embodiment this is carried out in a Barrel Asher chamber such as an Axic Plasmastar 200, sold by Axic, Santa Clara, Calif. The chamber is pumped down to 350 milliTorr and the process gas introduced (CF₄ with 4% O₂). A 13.56 MHz RF high frequency ion field is created between two electrodes at 350 Watts power which dissociates the gas into a plasma. The fluorine atoms react with the silicon wafer and cause it to be removed as a gas SiF₄. The process time can varied to result in different thicknesses of silicon removal. For chips and cracks having dimensions of several microns the process time is typically from 30 to 90 minutes. The isotropic etching results in a significant removal of the minute chips and cracks arising from the laser machining, and results in slots 12 having significantly smoother surfaces and edges and less residual debris. The wafers 10, and the dies ultimately cut from them, are therefore significantly less prone to breakage or macro-cracking.

Instead of using CF4, the isotropic etch can be carried out using a different plasma gas chemistry, such as one containing SF₆ or NF₃. Alternatively, it is possible to use wet etching to perform the isotropic etch by immersing the wafer in, for example, hydrofluoric acid, provided the front surface of the wafer is protected against the etchant. The invention is also not limited to the use of silicon wafers. For example, the invention may be applied to printheads constructed on silicon carbide or silicon nitride substrates.

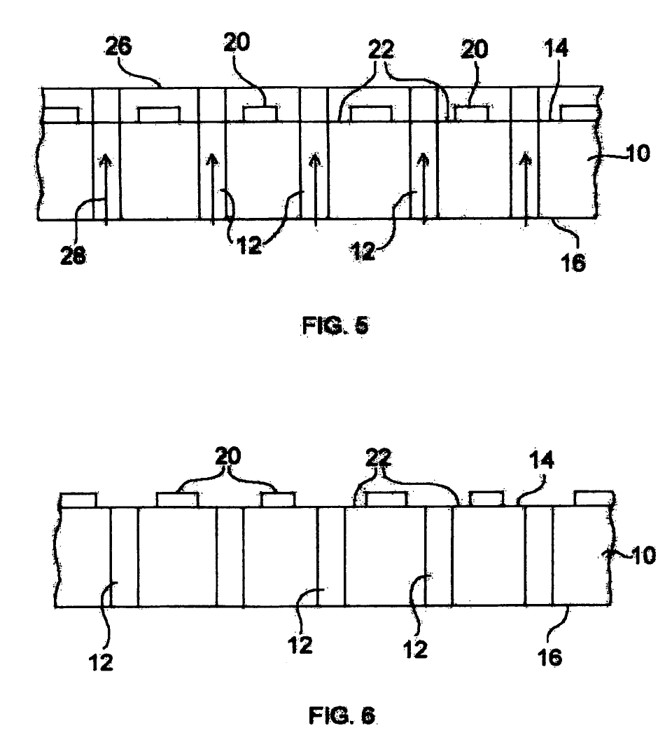

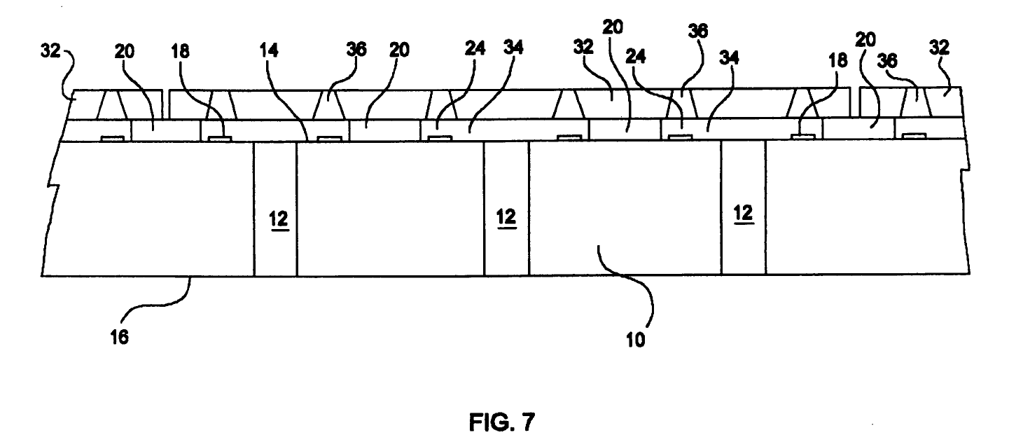

Next the PVA layer 26 is removed using water and PVA roller brushes, FIG. 6, following which pre-formed metallic nozzle plates 32 (FIG. 7) are applied to the top surface of the barrier layer 20 in a conventional manner, for example by bonding. The nozzle plates are applied on a die-by-die basis, i.e. individual nozzle plates 32 are applied to respective underlying portions of the wafer which will correspond in the subsequently divided wafer to individual printhead dies. The final composite structure, whose cross-section is seen in FIG. 7, comprises a plurality of ink ejection chambers 24 disposed along each side of each slot 12 although, since FIG. 7 is a transverse cross-section, only one chamber 24 is seen on each side of each slot 12. Each chamber 24 contains a respective resistor 18, and an ink supply path 34 extends from the slot 12 to each resistor 18. Finally, a respective ink ejection orifice 36 leads from each ink ejection chamber 24 to the exposed outer surface of the nozzle plate 32. It will be understood that the manufacture of the structure above the wafer surface 14, i.e. the structure containing the ink ejection chambers 24, the ink supply paths 34 and the ink ejection orifices 36 as described above, can be entirely conventional and well known to those skilled in the art.

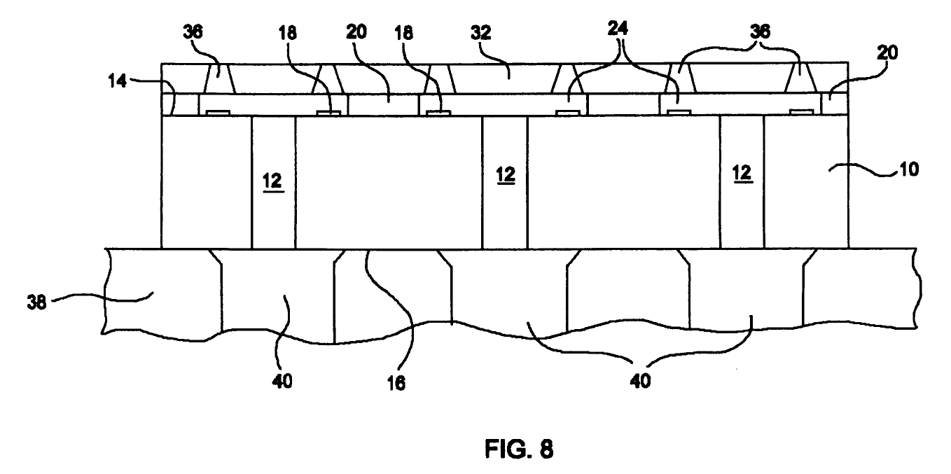

Finally, the wafer processed as above is diced to separate the individual printheads from the wafer and each printhead is mounted on a print cartridge body 38, FIG. 8, having respective apertures 40 for supplying ink from differently coloured ink reservoirs (not shown) to the printhead. To this end the printhead is mounted on the cartridge body 38 with each aperture 40 in fluid communication with a respective slot 12 in the wafer 10.

Although the slots 12 in each group of three slots are shown as disposed side by side, they could alternatively be disposed end to end or staggered or otherwise offset without departing from the scope of this invention. Also, in the case of a printhead which uses a single colour ink, usually black, only one ink supply slot 12 will be required per printhead.

Although the foregoing has described an embodiment where the slots 12 are laser machined part way through the processing of the wafer 10, they could be formed right at the beginning, i.e. on the raw wafer, or at any other suitable point in the wafer processing provided the thin film resistors and other circuitry latter, to the extent they are present, are suitably protected by PVA or other protective layer. Furthermore, the isotropic etch need not immediately follow the cutting of the slots 12, again provided that any circuitry already present is suitably protected.

It will also be seen that the slots 12 need not be fully removed using laser machining. For example, laser machining could be used to blind etch the slots to a final remaining thickness of, for example, less than the order of 10 μm. The isotropic etch could then be used both to open the slot and to remove the micron-sized chips and cracks as described above. This has the advantage of providing greater control of the breakthrough stage of the slotting process than with laser machining alone, particularly where the ink chambers are more completely defined before slotting.

To examine the affect of plasma etching on debris removal, the thin film side of laser drilled product wafers (which maintained a PVA coating) was pressed against a blank silicon ‘protection’ wafer. The ‘protection’ wafer was kept pressed against the thin film side by placing both wafers in the same slot of a quartz boat. The wafers were placed in a barrel etch configuration and etched. Three recipes were used:

| | | | | | | Etch |
|---|---|---|---|---|---|---|
| Recipe | O₂ | CF₄ | Pressure | Power | | Depth |
| No | (sccm) | (sccm) | (mT) | (W) | Time(min) | (microns) |
| 1 | 40 | 160 | 350 | 250 | 90 | 9.5 |
| 2 | 40 | 160 | 350 | 250 | 60 | 7 |
| 3 | 40 | 160 | 350 | 250 | 45 | 5.3 |

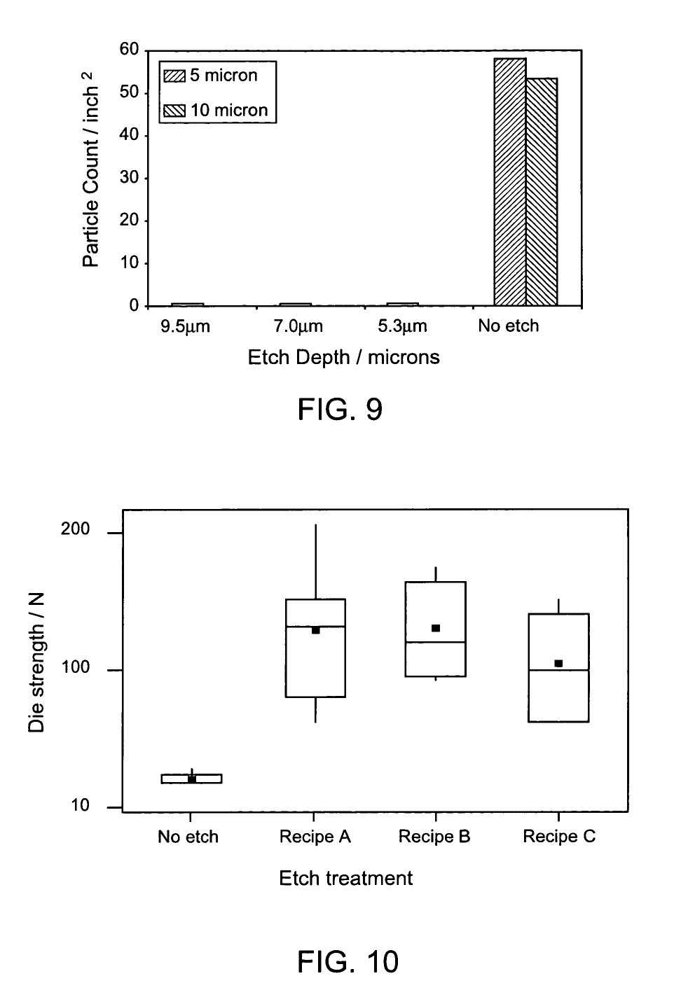

Each etch recipe corresponds to a different depth of material etched. The etch depth quoted is determined as the depth of silicon removed from an unslotted silicon wafer. Particle count measurements from etched and unetched slotted wafers were taken with a B5 QIII particle monitor. Two bin sizes were used, namely 5 μm and 10 μm. FIG. 9 is a chart comparing the particle count measured from slotted wafers that had been subject to plasma etching and wafers that had not been plasma etched. FIG. 9 shows the particle count for these two bin sizes measured from wafers etched according to 3 different recipes and from unetched wafers. For a given etch depth the data shown in FIG. 6 is the average count taken from two wafers which had undergone the same etch process.

It is clear that the plasma isotropic etch is efficient in significantly reducing the number of particles deposited during the laser slotting process.

To examine the effect of plasma etching on die strength, the slotted wafers were cut into individual die each having 3 slots. The average strength of the slotted die was measured using a 3 point bending test. A comparison was made between die from slotted wafers which had been plasma etched after the laser drill step and those that had not.

In FIGS. 10 to 12, the upper and lower ends of the lines extending from each box indicate the range of values measured for each recipe; the upper and lower ends of the boxes indicate the range bounded by the 75th and 25th centile measurements for a recipe; the horizontal line within each box indicates the median value; and the dot (where indicated) shows the mean value of the measurements for a recipe.

FIG. 10 shows die strength measurements of laser drilled only and plasma isotropically etched die. All die had 3 slots. The increases in die strength was found to be true for both wafers plasma etched in a parallel plate and the barrel etch configurations. FIG. 10 shows the die strength measured from wafers etched according to 3 different recipes and from an un-etched wafer. The wafers were etched in the barrel etch configuration. The plasma recipes used are as follows:

| | | | | | | Etch |
|---|---|---|---|---|---|---|
| Recipe | O₂ | CF₄ | Pressure | Power | | Depth |
| No | (sccm) | (sccm) | (mT) | (W) | Time(min) | (microns) |
| A | 3 | 42 | 350 | 250 | 90 | 5 |
| B | 4 | 42 | 350 | 250 | 90 | 6.8 |
| C | 8 | 42 | 350 | 250 | 90 | 10 |

It is clear from this plot that the mean die strength (denoted by the filled circle) is significantly higher for the plasma etched die than the unetched die. While the distribution in die strength is significantly greater in the case of the etched samples, the values of the mean are similar in each case and are of the order of 100 N as opposed to 20 N for the unetched die. The standard deviation is also similar for the three etched samples with values of 47.8 N, 35.0 N and 35.9 N for die subjected to recipe A, B, and C respectively.

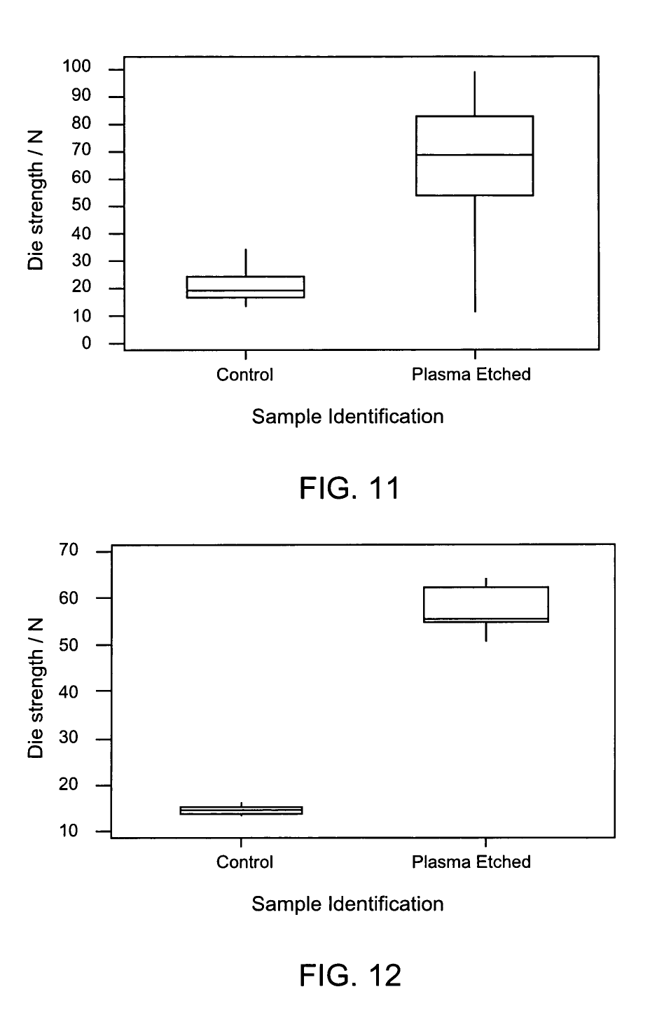

FIG. 11 shows die strength of (a) die post laser drill (control) and (b) post laser drill and plasma etched, using a parallel plate configuration, according to recipe: 10 sccm O₂, 42 sccm CF₄, 250 W, 350 mT, 90 mins. All die had 3 slots.

The boxplot shown in FIG. 11 shows the die strength measured from die taken from the laser drilled only control wafer and the wafer plasma etched using the parallel plate configuration (all die had 3 slots). The average strength of the die from the control wafer is calculated as 14.82 N. In comparison the average strength of the die from the plasma etched wafer is 57.23 N.

Thus, plasma isotropic etching increases die strength significantly over the unetched slotted die.

This increase in die strength for slotted silicon die was found also to be true for slots of different dimension. While FIG. 11 shows the die strength for silicon die with 3 slots per die, FIG. 12 shows the die strength of unetched and etched die which have 2 slots per die with longer length slots.

FIG. 12 shows die strength of (a) unetched die (2 slots per die) post laser drill (control) and (b) die post laser drill and plasma etched (2 slots per die), using a parallel plate configuration, according to recipe: 10 sccm 02, 42 sccm CF₄, 250 W, 350 mT, 90 mins.

The invention is not limited to the embodiment described herein and may be modified or varied without departing from the scope of the invention.

1. A method of making an inkjet printhead comprising, not necessarily in the order stated, forming at least one ink ejection element on a surface of a substrate, forming an opening in the substrate to provide fluid communication between an ink supply and the ink ejection element, and subjecting the opening to a substantially isotropic etch.

2. A method as claimed in claim 1, wherein the printhead is one of a plurality of such printheads formed substantially simultaneously on the substrate, the method further comprising dividing the substrate into individual printheads after forming the opening and etching.

3. A method as claimed in claim 1, further including covering the surface of the substrate with a protective etch-resistant layer prior to etching.

4. A method as claimed in claim 2, further including covering the surface of the substrate with a protective etch-resistant layer prior to etching.

5. A method as claimed in claim 3, wherein the protective layer comprises polyvinyl alcohol.

6. A method as claimed in claim 4, wherein the protective layer comprises polyvinyl alcohol.

7. A method as claimed claim 1, wherein etching is performed after the ink ejection element is at least partially formed on the surface of the substrate.

8. A method as claimed claim 2, wherein etching is performed after the ink ejection element is at least partially formed on the surface of the substrate.

9. A method as claimed claim 3, wherein etching is performed after the ink ejection element is at least partially formed on the surface of the substrate.

10. A method as claimed in claim 7, wherein the ink ejection element comprises thin film circuitry deposited on the surface of the substrate, a barrier layer applied over the thin film circuitry, and a nozzle plate applied over the barrier layer, the barrier layer and nozzle plate together defining the at least one ink ejection chamber, and wherein the etch is performed after the application of the barrier layer and before the application of the nozzle plate.

11. A method as claimed in claim 1, wherein the isotropic etch is a plasma etch.

12. A method as claimed in claim 2, wherein the isotropic etch is a plasma etch.

13. A method as claimed in claim 1, wherein the substrate is a semiconductor substrate.

14. A method as claimed in claim 2, wherein the substrate is a semiconductor substrate.

15. A method as claimed in claim 13, wherein the substrate is a silicon substrate.

16. A method as claimed in claim 11, wherein the plasma contains fluorine atoms which react with the silicon substrate to form gaseous silicon fluoride.

17. An inkjet printhead made by the method claimed in claim 1.

18. A print cartridge comprising a cartridge body having an aperture for supplying ink from an ink reservoir to a printhead, and a printhead as claimed in claim 17 mounted on the cartridge body with the aperture in fluid communication with an ink supply opening.

19. An inkjet printer including a print cartridge according to claim 18.
